(19) United States
(12) Patent Application Publication
(10) Pub. No.: US 2021/0136477 A1
(43) Pub. Date: May 6, 2021

(54) WIRELESS EARPHONE

(71) Applicant: Audio-Technica Corporation, Tokyo (JP)

(72) Inventor: Hiromichi OZAWA, Kanagawa (JP)

(21) Appl. No.: 16/962,927

(22) PCT Filed: Jul. 13, 2018
(86) PCT No.: PCT/JP2018/026524

§ 371 Date: Jul. 17, 2020

(30) Foreign Application Priority Data
Jan. 19, 2018 (JP) 2018-007026

(51) Int. Cl. H04R 1/10; H04R 1/06; H04R 19/01; H04R 1/04

(52) U.S. Cl. CPC H04R 1/1016; H04R 1/06; H04R 2420/07; H04R 1/04; H04R 19/016

(57) ABSTRACT

Provided is a wireless earphone capable of suppressing an influence on the sound quality of an electroacoustic transducer due to the arrangement of electrical parts such as a battery and a circuit board while reducing the size of a casing. The wireless earphone includes an electroacoustic transducer 14 that outputs a sound wave corresponding to a sound signal from a sound source S, a reception circuit 151 that receives the sound signal from the sound source S via a wireless communication line, a circuit board 15 to which the reception circuit 151 is attached, and a casing 11 that accommodates the circuit board 15 and the electroacoustic transducer 14. The casing 11 includes a first casing 11A that accommodates the electroacoustic transducer 14, and a second casing 11B that accommodates the circuit board 15.

### TECHNICAL FIELD

The present invention relates to a wireless earphone.

### BACKGROUND ART

A canal type earphone (hereinafter, referred to as an “earphone”) is one model of an earphone. In general, the earphone has a pair of left and right sound emitting units.

Each sound emitting unit includes a casing, an electroacoustic transducer, a sound conduit, an earpiece, and a cord. The casing includes an internal space therein and accommodates the electroacoustic transducer in the space. The electroacoustic transducer outputs sound waves corresponding to sound signals from a sound source such as a portable music player. The whole or a part of the casing is disposed in a cavity of concha of a user when the earphone is worn on an ear of the user (hereinafter, referred to as “when worn”). The internal space of the casing is divided by the electroacoustic transducer into a space (front space) in front of the electroacoustic transducer (in the direction toward the head of the user when the earphone is worn) and a space (rear space) in the rear of the electroacoustic transducer (in the direction opposite to the direction toward the head of the user when the earphone is worn). The sound conduit is attached to the casing. The sound conduit guides sound waves from the electroacoustic transducer to the space within the ear canal of the user when the earphone is in use. The earpiece is attached to the sound conduit. The earpiece comes into close contact with the inner wall of the ear canal of the user when worn. As a consequence, the space within the ear canal communicates with the front space via the sound conduit.

The cord connects the electroacoustic transducer to the sound source and supplies the electroacoustic transducer with the sound signals from the sound source. The cord includes a core wire that guides the sound signals to the electroacoustic transducer and a coating that protects the core wire.

In recent years, an earphone with the casing made smaller by disposing the electroacoustic transducer inside the sound conduit has been proposed (for example, see Japanese Unexamined Patent Application Publication No. 2010-81306).

### SUMMARY OF INVENTION

### Technical Problem

In the earphone disclosed in Japanese Unexamined Patent Application Publication No. 2010-81306, the electroacoustic transducer is disposed inside the sound conduit, and accordingly the electroacoustic transducer is limited in size to fit within the inner diameter of the sound conduit. When the size of the electroacoustic transducer is made smaller, the size of a diaphragm disposed inside the electroacoustic transducer is also reduced, resulting in degradation of sound quality as compared with an electroacoustic transducer with a large diaphragm.

In the earphone with the cord, the cord is connected to the casing and the sound source. Therefore, the movement of a user can be easily restricted. Accordingly, disconnection of a core wire due to strong pulling of the cord, detachment of the earphone from the ear of the user, and the like may occur.

In this regard, in recent years, a wireless type earphone with no cord (hereinafter, referred to as a “wireless earphone”) has been proposed. The wireless earphone receives sound signals from a sound source via a wireless communication line such as Bluetooth (registered trademark), for example. The wireless earphone includes a wireless earphone in which left and right sound emitting units are connected by a cable, and what is called a complete wireless earphone in which left and right sound emitting units are completely independent (the left and right sound emitting units are not connected by a cable). Since the complete wireless earphone includes no cable that connects the left and right sound emitting units, the complete wireless earphone has a higher degree of freedom in designing the sound emitting units than the wireless earphone in which the left and right sound emitting units are connected by a cable.

The complete wireless earphone includes electrical parts such as a battery and a circuit board disposed in the casing. In the internal space of the casing, the electrical parts such as a battery and a circuit board are disposed in the rear space of an electroacoustic transducer.

However, in the rear space, when the electroacoustic transducer is disposed near the electrical parts such as a battery and a circuit board, acoustic characteristics of the rear space are changed, resulting in degradation of the sound quality of the electroacoustic transducer (sound quality of sound waves output from the electroacoustic transducer). In contrast, when the electroacoustic transducer and the electrical parts such as a battery and a circuit board are disposed apart from each other, the volume of the internal space of the casing increases, resulting in an increase in the casing. In such a case, as described above, since the whole or a part of the casing is disposed in the cavity of concha of a user, when the casing becomes large, the wearing comfort of the earphone of the user deteriorates.

When the electroacoustic transducer is disposed in the sound conduit as in the earphone disclosed in Japanese Unexamined Patent Application Publication No. 2010-81306, a gap is formed in the internal space of the casing, so that the electrical parts such as a battery and a circuit board can be disposed. However, as described above, since the size of the electroacoustic transducer disposed in the sound conduit is limited to a small size, the sound quality of the electroacoustic transducer is degraded.

An object of the present invention is to solve the problem in related art as described above and to provide a wireless earphone capable of suppressing an influence on the sound quality of an electroacoustic transducer due to the arrangement of electrical parts such as a battery and a circuit board while reducing the size of a casing.

### Solution to Problem

A wireless earphone according to the present invention includes an electroacoustic transducer configured to output a sound wave corresponding to a sound signal from a sound source, a reception circuit configured to receive the sound signal from the sound source via a wireless communication line, a circuit board to which the reception circuit is attached, and a casing that accommodates the circuit board and the electroacoustic transducer. The casing includes a first casing that accommodates the electroacoustic transducer, and a second casing that accommodates the circuit board.

### Advantageous Effects of the Invention

According to the present invention, a wireless earphone can suppress an influence on the sound quality of an electroacoustic transducer due to the arrangement of electrical parts such as a battery and a circuit board while reducing the size of a casing.

### BRIEF DESCRIPTION OF DRAWINGS

FIG. 1 is a perspective view illustrating an embodiment of a wireless earphone according to the present invention.

FIG. 2 is a front view of a left sound emitting unit included in the wireless earphone in FIG. 1.

FIG. 3 is a cross-sectional view taken along line A-A of the left sound emitting unit in FIG. 2.

FIG. 4 is a functional block diagram of the wireless earphone in FIG. 1.

### DESCRIPTION OF EMBODIMENTS

### Wireless Earphone

Embodiments of a wireless earphone according to the present invention will now be described with reference to the attached drawings.

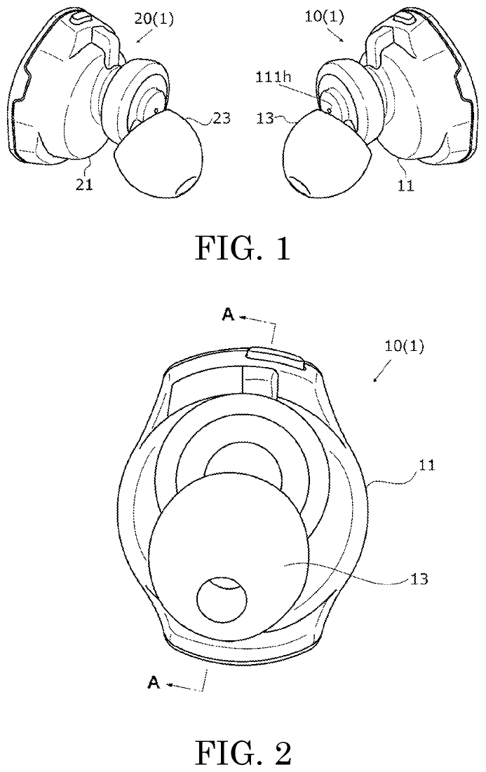

FIG. 1 is a perspective view illustrating an embodiment of a wireless earphone according to the present invention.

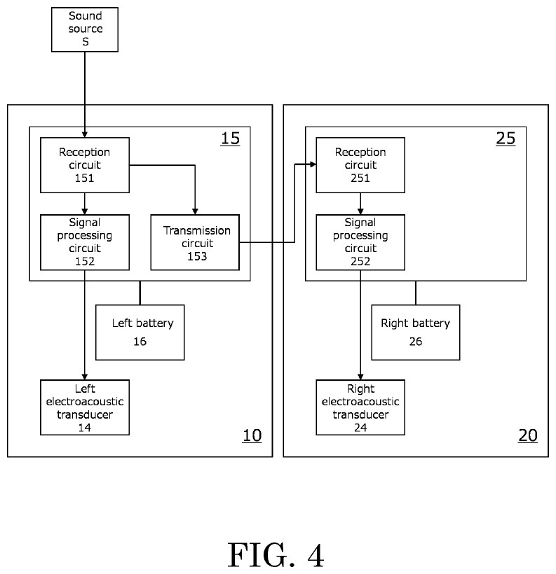

A wireless earphone 1 is worn on an ear of a user of the wireless earphone 1 and outputs sound waves corresponding to sound signals from a sound source S (see FIG. 4) such as a portable music player. The wireless earphone 1 receives the sound signals from the sound source S via a wireless communication line such as Bluetooth (registered trademark), for example.

The wireless earphone 1 includes a left sound emitting unit 10 and a right sound emitting unit 20. The wireless earphone 1 is what is called a complete wireless earphone in which the left sound emitting unit 10 and the right sound emitting unit 20 are completely independent without being connected by a cable and the like.

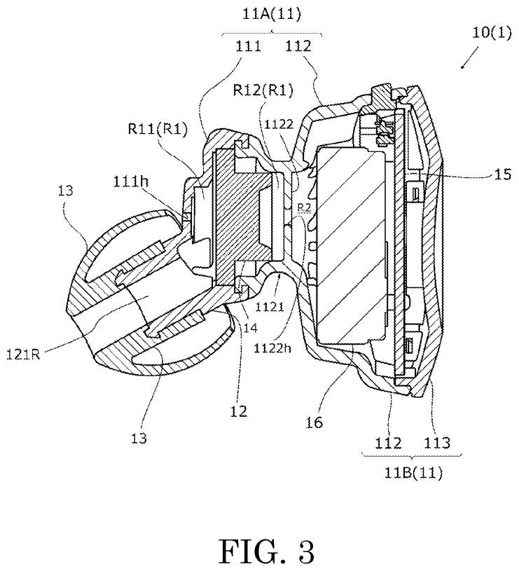

In the following description, the front side of the wireless earphone 1 is a direction toward the head of the user (the left side in FIG. 3) in a state in which the wireless earphone 1 is worn on the head of the user (hereinafter, referred to a “wearing state”). The rear side of the wireless earphone 1 is a direction opposite to the direction toward the head of the user (the right side in FIG. 3) in the wearing state.

### Configuration of Wireless Earphone

FIG. 2 is a front view of the left sound emitting unit 10.

FIG. 3 is a cross-sectional view of the left sound emitting unit 10 taken along line A-A in FIG. 2.

First, the left sound emitting unit 10 will be described.

The left sound emitting unit 10 is worn on the left ear of the user and outputs the sound waves corresponding to the sound signals from the sound source S (see FIG. 4). The left sound emitting unit 10 includes a left casing 11, a left sound conduit 12, a left earpiece 13, a left electroacoustic transducer 14, a left circuit board 15, and a left battery 16.

The left casing 11 accommodates the left electroacoustic transducer 14, the left circuit board 15, and the left battery 16. The left casing 11 is made of synthetic resin such as plastic, for example. The left casing 11 includes a first housing 111, a second housing 112, and a third housing 113.

The first housing 111 accommodates the left electroacoustic transducer 14 together with the second housing 112. The first housing 111 has a substantially bowl shape opened rearward. The first housing 111 includes a communication hole 111h disposed at the bottom thereof. The communication hole 111h will be described below.

The second housing 112 accommodates the left electroacoustic transducer 14 together with the first housing 111. Furthermore, the second housing 112 accommodates the left circuit board 15 and the left battery 16 together with the third housing 113. The second housing 112 has a substantially drum shape opened in the front direction and the rear direction. The second housing 112 includes a constriction part 1121 and a partition part 1122.

The constriction part 1121 is disposed on the antitragus of the left ear of the user in the wearing state and fixes the left casing 11 to the left ear.

The partition part 1122 is disposed inside the constriction part 1121 and divides (partitions) a space inside the second housing 112 back and forth. The partition part 1122 includes a communication hole 1122h. The communication hole 1122h is disposed in the center of the partition part 1122 and allows the spaces inside the second housing 112 partitioned by the partition part 1122 back and forth to communicate with each other.

The third housing 113 accommodates the left circuit board 15 and the left battery 16 together with the second housing 112. The third housing 113 has a substantially dish shape.

The first housing 111 is joined to an opening on the front side of the second housing 112 and covers the opening. The third housing 113 is joined to an opening on the rear side of the second housing 112 and covers the opening. As a consequence, the first housing 111 constitutes a first casing 11A in the present invention together with a part of the second housing 112 on the front side of the partition part 1122. The third housing 113 constitutes a second casing 11B in the present invention together with a part of the second housing 112 on the rear side of the partition part 1122. That is, the left casing 11 includes the first casing 11A and the second casing 11B disposed behind the first casing 11A with the partition part 1122 (the constriction part 1121) as a boundary. In other words, the first casing 11A is joined to the second casing 11B at the partition part 1122 (the constriction part 1121).

The first casing 11A includes the first housing 111 and the second housing 112. The second casing 11B includes the second housing 112 and the third housing 113. That is, the second housing 112 is a member that is common to the first casing 11A and the second casing 11B.

The first casing 11A accommodates the left electroacoustic transducer 14. The first casing 11A is a part located on the front side of the partition part 1122 of the left casing 11. The first casing 11A includes a first space R1 therein. The first space R1 is a space inside the first casing 11A formed by (divided into) the first housing 111 and the second housing 112.

The second casing 11B accommodates the left circuit board 15 and the left battery 16. The second casing 11B is a part located on the rear side of the partition part 1122 of the left casing 11. The second casing 11B includes a second space R2 therein. The second space R2 is a space inside the second casing 11B formed by (divided into) the second housing 112 and the third housing 113. The second space R2 communicates with the first space R1 via the communication hole 1122h.

The left sound conduit 12 guides the sound waves from the left electroacoustic transducer 14 to the external auditory meatus of the user when the wireless earphone 1 is in use. The left sound conduit 12 has a substantially cylindrical shape. That is, the left sound conduit 12 is provided therein with a space (hereinafter, referred to as an “internal space”) 121R through which the sound waves from the left electroacoustic transducer 14 pass. The left sound conduit 12 is disposed in front of the first housing 111, and is configured integrally with the first housing 111 so as to protrude downward in the front direction (downward in FIG. 3) from the bottom of the first housing 111. In other words, the first housing 111 includes the left sound conduit 12 protruding from the bottom. The internal space 121R communicates with the first space R1.

Note that the left sound conduit may be configured separately from the first housing as long as the internal space communicates with the first space. That is, for example, the left sound conduit may be jointed to the bottom of the first housing and protrude from the bottom of the first housing. That is, the first housing may be configured to be joined to the left sound conduit.

The left earpiece 13 comes into close contact with the inner wall of the external auditory meatus of the user in the wearing state. The left earpiece 13 is attached to the outer peripheral surface of the left sound conduit 12. The left earpiece 13 is an elastic member such as silicon rubber, for example. The left earpiece 13 has a substantially double cylindrical shape in which a front end side is folded back in a U shape in the cross-sectional view.

The left electroacoustic transducer 14 outputs the sound waves corresponding to the sound signals from the sound source S. The left electroacoustic transducer 14 is, for example, a dynamic electroacoustic transducer. The left electroacoustic transducer 14 is disposed in the first space R1 of the first casing 11A in the left casing 11 (accommodated in the first casing 11A). As illustrated in FIG. 3, the first space R1 is divided into a front space R11 and a rear space R12 by the left electroacoustic transducer 14.

The front space R11 is a space in front of the left electroacoustic transducer 14 in the first space R1. The rear space R12 is a space behind the left electroacoustic transducer 14 in the first space R1, and is located on the second space R2 side. The front space R11 and the rear space R12 are spaces having an acoustic volume.

The front space R11 communicates with a space outside the left casing 11 via an acoustic resistor (not illustrated) and the communication hole 111h. That is, the communication hole 111h is a hole that allows the front space R11 and the space outside the left casing 11 to communicate with each other. Among the sound waves from the left electroacoustic transducer 14, sound waves in a low frequency range are emitted from the communication hole 111h to the space outside the left casing 11. Therefore, the low frequency range of each sound wave emitted by the left sound emitting unit 10 is suppressed. Furthermore, the communication hole 111h suppresses an increase in pressure in the front space R11, which is generated when the left sound emitting unit 10 is worn on the left ear of the user (when the left sound emitting unit 10 is worn on the auricle of the user), and prevents damage to the left electroacoustic transducer 14 (for example, damage to a diaphragm (not illustrated) included in the left electroacoustic transducer 14).

The left circuit board 15 is a board to which the below-described electronic circuits are attached (mounted). The left circuit board 15 is disposed in the second space R2 of the second casing 11B (accommodated in the second casing 11B).

FIG. 4 is a functional block diagram of the wireless earphone 1.

The left circuit board 15 includes a reception circuit 151, a signal processing circuit 152, and a transmission circuit 153 mounted thereon. The reception circuit 151, the signal processing circuit 152, and the transmission circuit 153 are examples of the electronic circuits described above. That is, the left sound emitting unit 10 includes the reception circuit 151, the signal processing circuit 152, and the transmission circuit 153. The left circuit board 15 is, for example, a printed circuit board (PCB).

The reception circuit 151 receives the sound signal from the sound source S via a wireless communication line. The sound signal received by the reception circuit 151 is a digital signal. The reception circuit 151 transmits the received sound signal to the signal processing circuit 152 and the transmission circuit 153. The signal processing circuit 152 processes the sound signal received by the reception circuit 151 and transmits the processed signal to the left electroacoustic transducer 14. The signal processing circuit 152 is, for example, a D/A conversion circuit. That is, the signal processed by the signal processing circuit 152 (hereinafter, referred to as a “processed signal”) is, for example, an analog signal obtained by D/A converting the digital signal. The transmission circuit 153 transmits the sound signal from the reception circuit 151 to the below-described reception circuit 251 of the right sound emitting unit 20. The reception circuit 151, the signal processing circuit 152, and the transmission circuit 153 are attached to the left circuit board 15.

The left battery 16 supplies electric power for driving the electronic circuits attached to the left circuit board 15 to the electronic circuits. The left battery 16 is, for example, a button-type small battery. The left battery 16 supplies the electric power to the reception circuit 151, the signal processing circuit 152, and the transmission circuit 153 via the left circuit board 15.

Referring now bock to FIG. 3, the left battery 16 is disposed in the second space R2 of the second casing 11B together with the left circuit board 15. As illustrated in FIG. 3, in the second space R2, the left circuit board 15 is disposed behind the left battery 16.

The left electroacoustic transducer 14 is connected to the left circuit board 15 via a signal line inserted into the communication hole 1122h. The communication hole 1122h, into which the signal line is inserted, is filled with, for example, an adhesive to be blocked. Therefore, the first space R1, where the left electroacoustic transducer 14 is disposed, is separated from the second space R2, where the left circuit board 15 and the left battery 16 are disposed. As described above, the first space R1 and the second space R2 are separated from each other, so that the acoustic characteristics of the rear space R12 are stable without being affected by the left circuit board 15 and the left battery 16. That is, the sound waves emitted from the left electroacoustic transducer 14 to the first space R1 are not affected by the left circuit board 15 and the left battery 16. As a consequence, the sound quality of the left electroacoustic transducer 14 is stable.

The left sound emitting unit 10 configured as described above is worn on the left ear of the user when the wireless earphone 1 is in use. At this time, the first casing 11A is disposed in the cavity of concha of the left ear of the user, and a part of the partition part 1122 (the constriction part 1121) is supported (disposed) by the tragus and antitragus of the left ear of the user and the second casing 11B is disposed outside the cavity of concha. That is, the second casing 11B is exposed to the outside of the cavity of concha in the wearing state. Specifically, in the wearing state, the left electroacoustic transducer 14 is located inside the cavity of concha and the electrical parts such as the left circuit board 15 and the left battery 16 are located outside the cavity of concha.

The right sound emitting unit 20 is worn on the right ear of the user and outputs the sound waves corresponding to the sound signals from the sound source S (see FIG. 4). The configuration of the right sound emitting unit 20 is common to that of the left sound emitting unit 10, except that the right sound emitting unit 20 includes no transmission circuit. That is, the right sound emitting unit 20 includes a right casing 21, a right sound conduit (not illustrated), a right earpiece 23, a right electroacoustic transducer 24, a right circuit board 25, and a right battery 26. The right casing 21 includes a first casing 21A and a second casing 21B. A reception circuit 251 and a signal processing circuit 252 are attached to the right circuit board 25.

### Operation of Wireless Earphone

The operation of the wireless earphone 1 will now be described with reference to FIG. 4.

The digital signals (sound signals) from the sound source S are transmitted to the reception circuit 151 of the left sound emitting unit 10 via the wireless communication line. The reception circuit 151 transmits the received digital signals (sound signals) to the signal processing circuit 152 and the transmission circuit 153.

The signal processing circuit 152 converts the digital signals (sound signals) input from the reception circuit 151 into analog signals (sound signals), and transmits the analog signals to the left electroacoustic transducer 14. The left electroacoustic transducer 14 outputs sound waves based on the analog signals (sound signals) input from the signal processing circuit 152.

On the other hand, the transmission circuit 153 transmits the digital signals (sound signals) transmitted from the reception circuit 151 to the reception circuit 251 of the right sound emitting unit 20. The reception circuit 251 transmits the digital signals (sound signals) transmitted from the transmission circuit 153 of the left sound emitting unit 10 to the signal processing circuit 252. The signal processing circuit 252 converts the digital signals (sound signals) input from the reception circuit 251 into analog signals (sound signals), and transmits the analog signals to the right electroacoustic transducer 24. The right electroacoustic transducer 24 outputs sound waves based on the analog signals (sound signals) input from the signal processing circuit 252.

### CONCLUSION

According to the embodiment described above, the left electroacoustic transducer 14 is accommodated in the first space R1 of the first casing 11A, and the electrical parts such as the left circuit board 15, to which the reception circuit 151 is attached, and the left battery 16 are accommodated in the second space R2 of the second casing 11B. The first space R1 is separated from the second space R2 by the partition part 1122. As a consequence, the left electroacoustic transducer 14 is disposed spatially separated from the electrical parts such as the left circuit board 15 and the left battery 16.

The wireless earphone according to the present invention enables a physical distance between the left electroacoustic transducer 14 and the electrical parts to be shortened, since the left electroacoustic transducer 14 and the electrical parts such as the left circuit board 15 and the left battery 16 are disposed spatially separated (apart) from each other. That is, in the wireless earphone according to the present invention, the physical distance between the electroacoustic transducer and the electrical parts can be shortened without affecting the acoustic characteristics of the rear space, resulting in a decrease in the size of the wireless earphone, as compared with the conventional earphone in which the electroacoustic transducer and the electrical parts such as the circuit board and the battery are disposed in the same space.

Moreover, when the first casing 11A is disposed in the cavity of concha, the second casing 11B is disposed (exposed) to the outside of the cavity of concha. That is, the electrical parts such as the left circuit board 15 and the left battery 16 are disposed outside the cavity of concha and the left electroacoustic transducer 14 is disposed in the cavity of concha. As a consequence, the wireless earphone according to the present invention enables the volume of the housing exposed to the outside of the cavity of concha to be reduced without deteriorating the wearing comfort of the user, as compared with the conventional earphone. Furthermore, the size of the electroacoustic transducer in the present invention can be selected to be larger than that of an electroacoustic transducer disposed in the sound conduit and of an electroacoustic transducer disposed in the same space as that where the electrical parts are disposed. As a consequence, in the wireless earphone according to the present invention, the degree of freedom in the selection of the electroacoustic transducer is increased, resulting in the improvement of sound quality.

As described above, the wireless earphone according to the present invention is a complete wireless earphone with the circuit board and the battery accommodated in the housing, and achieves both miniaturization and suppression of influence on sound quality.

Note that the wireless earphone according to the embodiment described above has a configuration in which the left and right electroacoustic transducers convert analog signals into sound waves. Alternatively, the left and right electroacoustic transducers can be configured to convert digital signals into sound waves. In such a case, the signal processing circuit processes sound signals, which are received by the reception circuit, in a digital signal state (for example, the process includes selecting, extracting, or synthesizing necessary signals), and transmits the processed signals to the left and right electroacoustic transducers.

Furthermore, the communication hole that allows the first space and the second space to communicate with each other may not be filled with an adhesive. In such a case, the second space functions as a rear space of the electroacoustic transducer (the left and right electroacoustic transducers) together with the first space.

Moreover, the second housing may include a communication hole that allows the rear space and the space outside the left and right casings (first casing) to communicate with each other. In such a case, the rear space can be acoustically regarded as a part of the space outside the left and right casings. Therefore, the stiffness of the air in the rear space becomes small, and vibrations of the diaphragms included in the left and right electroacoustic transducers are hardly braked by the air in the rear space. As a consequence, in the second housing, the volume of the rear space can be reduced as compared with the left and right casings that do not include the communication hole, resulting in downsize of the left and right casings.

1. A wireless earphone comprising:
an electroacoustic transducer configured to output a sound wave corresponding to a sound signal from a sound source;
a reception circuit configured to receive the sound signal from the sound source via a wireless communication line;
a circuit board to which the reception circuit is attached; and
a casing that accommodates the circuit board and the electroacoustic transducer, wherein
the casing includes:
a first casing that accommodates the electroacoustic transducer; and
a second casing that accommodates the circuit board.

2. The wireless earphone according to claim 1, further comprising a sound conduit including an internal space through which the sound wave passes, wherein
the first casing includes a first space that communicates with the internal space.

3. The wireless earphone according to claim 2, wherein
the first casing is joined to the second casing, and
the second casing includes a second space that communicates with the first space.

4. The wireless earphone according to claim 3, wherein the first space is divided into a front space communicating with the internal space and a rear space located on a side of the second space by the electroacoustic transducer.

5. The wireless earphone according to claim 3, wherein
the first casing includes:
a first housing; and
a second housing joined to the first housing, and
the second casing includes:
the second housing; and
a third housing joined to the second housing.

6. The wireless earphone according to claim 5, wherein
the first housing includes the sound conduit, and
the first housing is configured integrally with the sound conduit.

7. The wireless earphone according to claim 5, wherein
the first housing is configured separately from the sound conduit, and
the first housing is joined to the sound conduit.

8. The wireless earphone according to claim 5, wherein the second housing includes a communication hole that allows the first space and the second space to communicate with each other.

9. The wireless earphone according to claim 5, wherein
the second housing includes a constriction part, and
when the wireless earphone is worn on an ear of a user, a part of the constriction part is supported by an antitragus of the ear.

10. The wireless earphone according to claim 8, wherein the electroacoustic transducer is connected to the circuit board via a signal line inserted into the communication hole.

11. The wireless earphone according to claim 10, wherein the communication hole, into which the signal line is inserted, is blocked.

12. The wireless earphone according to claim 1, wherein, when the first casing is disposed in a cavity of concha, at least a part of the second casing is exposed to an outside of the cavity of concha.

13. The wireless earphone according to claim 1, further comprising a battery that supplies electric power to the reception circuit, wherein
the battery is accommodated in the second casing.

14. The wireless earphone according to claim 1, further comprising a battery that supplies electric power to the reception circuit, wherein
the battery is accommodated in the second casing,
the second casing is disposed behind the first casing, and
the circuit board is disposed behind the battery.

15. The wireless earphone according to claim 1, further comprising:
a first space where the electroacoustic transducer is disposed;
a second space where the circuit board is disposed; and
a communication hole that allows the first space and the second space to communicate with each other, wherein
the electroacoustic transducer is connected to the circuit board via a signal line inserted into the communication hole, and
the communication hole, into which the signal line is inserted, is blocked.

16. The wireless earphone according to claim 1, wherein
the first casing includes:
a first housing;
a second housing joined to the first housing; and
a first space divided by the first housing and the second housing,
the second casing includes:
a second space that communicates with the first space, and
the second housing includes:
a constriction part; and
a partition part disposed inside the constriction part.

17. The wireless earphone according to claim 16, wherein the first space is separated from the second space by the partition part.
